(19) United States
(12) Patent Application Publication
(10) Pub. No.: US 2006/0231149 A1
(43) Pub. Date: Oct. 19, 2006

(54) ORIFICE FLOW METERS

(75) Inventor: Kedar A. Kulkarni, Aundh, Pune (IN)

Correspondence Address: CONLEY ROSE, P.C., P. O. BOX 3267, HOUSTON, TX, 77253-3267, US

(73) Assignee: DANIEL INDUSTRIES, INC., Houston, TX (US)

(21) Appl. No.: 11/379,240

(22) Filed: Apr. 19, 2006

(30) Foreign Application Priority Data
Apr. 19, 2005 (IN) 482/MUM/2005
Apr. 19, 2005 (IN) 483/MUM/2005
Apr. 19, 2005 (IN) 484/MUM/2005

(51) Int. Cl. G01F 1/42

(52) U.S. Cl. 138/44

(57) ABSTRACT

An orifice flow meter for measuring flow rate through a conduit. In an embodiment, the orifice flow meter comprises a tubular body having a through passage. In addition, the orifice flow meter comprises an orifice plate assembly removably disposed within the body across the through passage, wherein the orifice plate assembly includes an orifice plate disposed between a first ring and a second ring, and wherein a first seal assembly is disposed between the first ring and the orifice plate, and a second seal assembly is disposed between the second ring and the orifice plate.

### CROSS-REFERENCE TO RELATED APPLICATIONS

The present application claims priority to Indian Application Nos. 482/MUM/2005; 483/MUM/2005; and 484/MUM/2005, each filed Apr. 19, 2005. The present application is related to 35 U.S.C. 111(b) provisional application Ser. No. 60/722,498 filed Sep. 30, 2005, and entitled Orifice Flow Meters.

### STATEMENT REGARDING FEDERALLY SPONSORED RESEARCH OR DEVELOPMENT

Not applicable.

### BACKGROUND OF THE INVENTION

1. Field of the Invention

The present invention relates generally to flow meters. Particularly, the invention relates to an orifice plate assembly for use in orifice flow meters,

2. Background of the Invention

Flow rate is the quantification of bulk fluid or gas movement, typically measured as volumetric and mass flow rates. The ability to reliably and accurately measure fluid flow rates may serve an important function in a variety of processes and industries (e.g, chemical processing, oil and gas production, etc.),

An orifice flow meter is one of many devices that may be used to measure volumetric or mass flow rate of fluids flowing through a pipe or conduit. An orifice flow meter typically employs a flat thin orifice plate having a reduced diameter orifice in the center supported and aligned within the orifice flow meter between a sealing ring and a compression ring that are held together by a fastener to form an orifice plate assembly. The fluid flow rate is calculated from the pressure differential across the orifice plate, the static pressure, the temperature, the density of the fluid flowing through the flow meter, and the size of the piper

When using an orifice plate to measure fluid flow, there are many factors to be considered in obtaining accurate flow measurements. The configuration and arrangement of seals within the orifice plate assembly is an important consideration. In particular, one or more seals may be provided in the orifice plate assembly to reduce the potential for flowing fluid to bypass the orifice in the orifice plate, instead leaking out of the orifice plate assemnbly between the orifice plate and sealing ring. Fluid leakage from the orifice plate assembly may result in erroneous flow measurements.

Generally, the seal ring is positioned on upstream side of the orifice plate and the compression ring is positioned on the downstream side of the orifice plate when the orifice plate assembly is positioned within the orifice flow meter to measure flow rates. In some conventional orifice plate seal assemblies, a seal may be provided between the seal ring and orifice plate, but no seal is provided between the orifice plate and the compression ring. In such assemblies, if the compression ring side of the orifice plate assembly is accidentally or inadvertently positioned upstream when the assembly is positioned within the orifice flow meter, leakage may occur, thereby detrimentally affecting flow measurements.

In addition, the configuration and arrangement of the orifice plate assembly may impact tolerancing, manufacturing complexity, and associated manufacturing costs. In general, manufacturing costs of an orifice plate assembly may be reduced by reducing the number of components required to reliably seal the orifice plate. Additional components may result in additional inventory requirements (e.g., stock on-hand of each component) at the operations site, may result in increased tolerancing demands for each individual part so that the combined orifice plate assembly is reliably sealed, and may require additional manufacturing/repair steps. Each of these consequences may contribute to increased manufacturing costs and complexities.

Thus, there remains a need to develop methods and apparatus for more reliable means to seal the orifice plate of an orifice flow meter, which overcome some of the foregoing difficulties while providing more advantageous overall results. In particular, there is a need for improved methods and devices to bi-directionally seal the orifice plate of an orifice flow meter. In addition, there is a need for improved methods and devices for orifice plate seal assemblies with reduced complexity and associated manufacturing and assembly costs.

### BRIEF SUMMARY OF SOME OF THE PREFERRED EMBODIMENTS

These and other needs in the art are addressed in one embodiment by an orifice flow meter for measuring flow rate through a conduit. In an embodiment, the orifice flow meter comprises a tubular body having a through passage. In addition, the orifice flow meter comprises an orifice plate assembly disposed within the body across the through passage, wherein the orifice plate assembly includes an orifice plate disposed between a first ring and a second ring, and wherein a first seal assembly is disposed between the first ring and the orifice plate, and a second seal assembly is disposed between the second ring and the orifice plate

These and other needs in the art are addressed in another embodiment by an orifice plate assembly for an orifice flow meter. In an embodiment, the orifice plate assembly comprises a first ring. In addition, the orifice plate assembly comprises a second ring. Further, the orifice plate assembly comprises an orifice plate disposed between the first ring and the second ring. Still further, the orifice plate assembly comprises at least one fastener integral with the first ring, wherein the fastener is operable to releasably engage the second ring.

These and other, needs in the art are addressed in another embodiment by an orifice plate assembly for an orifice flow meter. In an embodiment, the orifice plate assembly comprises a first ring. In addition, the orifice plate assembly comprises a second ring. Further, the orifice plate assembly comprises an orifice plate disposed between the first ring and the second ring. Still further, the orifice plate assembly comprises a first seal assembly disposed between the first ring and the orifice plate. Moreover, the orifice plate assembly comprises a second seal assembly disposed between the second ring and the orifice plate,

The foregoing has outlined rather broadly the features and technical advantages of embodiments of the present invention in order that the detailed description that follows may be better understood. Additional features and advantages of embodiments of the invention will be described hereinafter that form the subject of the claims. It should be appreciated by those skilled in the art that the conception and the specific embodiments disclosed may be readily utilized as a basis for modifying or designing other structures for carrying out the same purposes of embodiments of the present invention. It should also be realized by those skilled in the art that such equivalent constructions do not depart from the spirit and scope of embodiments of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a partial sectional view of an embodiment of an orifice flow meter;

FIG. 2 illustrates a partial sectional view of an embodiment of a bi-directional orifice assembly;

FIG. 3 illustrates a partial top view of the bi-directional orifice assembly of FIG. 2;

FIG. 4 illustrates a partial sectional view of the bi-directional orifice assembly of FIG. 2 with a fastener in the locked position;

FIG. 5 illustrates a partial sectional view of the bi-directional orifice plate assembly of FIG. 2 with a fastener in the unlocked position;

FIG. 6 illustrates a partial sectional view of another embodiment of a bi-directional orifice assembly with a fastener in the locked position; and

FIG. 7 illustrates a partial sectional view of the bi-directional orifice plate assembly of FIG. 6 with a fastener in the unlocked position.

### DETAILED DESCRIPTION OF THE PREFERRED EMBODIMENT

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections,

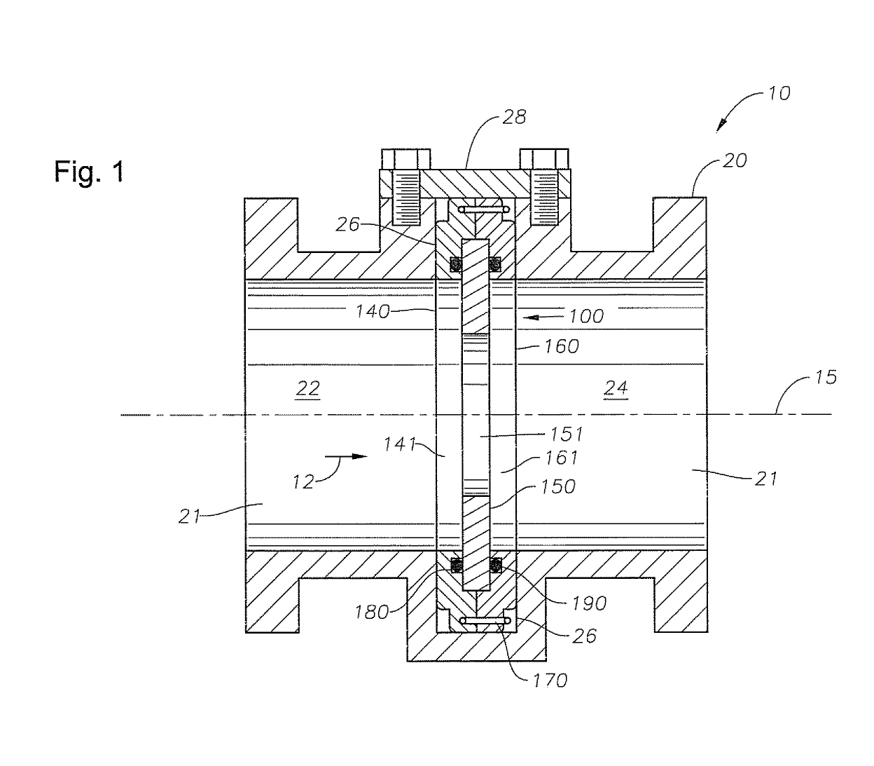

FIG. 1 illustrates schematically an orifice flow meter 10. The orifice flow meter 10 comprises a body 20 and an orifice plate assembly 100. Body 20 is a generally tubular conduit having a central axis 15 and a through passage 21 through which a fluid flows from an upstream region 22 to a downstream region 24 generally in the direction of arrow 12. In addition, body 20 includes a carrier guide 26 within which orifice plate assembly 100 is removably disposed. When orifice plate assembly 100 is inserted or removed from orifice flow meter 10, carrier guide 26 serves as a guide to properly locate, align, and position orifice plate assembly 100 within flow meter 10. Specifically, carrier guide 26 orients orifice plate assembly 100 substantially perpendicular to the direction of fluid flow. When orifice plate assembly 100 is properly positioned within carrier guide 26, orifice plate assembly 100 spans the entire diameter of through passage 21

A cap 28 is coupled to body 20 and positioned generally across an otherwise open portion of carrier guide 26. Orifice plate assembly 100 may be accessed by removing cap 28 and sliding orifice plate assembly 100 out of carrier guide 26 and body 20. With cap 28 removed from body 20, orifice plate assembly 100 may be reinserted or replaced within orifice flow meter 10 by inserting orifice plate assembly 100 into carrier guide 26. Once orifice plate assembly 100 is completely and properly disposed within carrier guide 26, cap 28 may be coupled to body 20 across the open portion of carrier guide 26, thereby securing orifice plate assembly 100 within orifice flow meter 10.

Orifice plate assembly 100 comprises a first ring 140, an orifice plate 150, and a second ring 160. Orifice plate 150 is removably disposed between first ring 140 and second ring 160. Specifically, first ring 140 and second ring 160 engage the outermost radial portions of orifice plate 150. Orifice plate 150 is securely held and aligned between first ring 140 and second ring 160 by one or more fasteners 170 that clamp the outer radial portions of first ring 140 to the outer radial portions of second ring 160, thereby holding orifice plate assembly 100 together. Further, each fastener 170 holds first ring 140, orifice plate 150, and second ring 160 together so that orifice plate assembly 100 may be disposed in carrier guide 26 of orifice flow meter 10.

First ring 140 includes a bore or hole 141, orifice plate 150 includes a central orifice 151, and second ring 160 includes a bore or hole 161. When first ring 140, orifice plate 150, and second ring 160 are assembled into orifice plate assembly 100, the central axis of hole 141, central orifice 151, and hole 161 are generally aligned. Further, when orifice assembly 100 is properly disposed within orifice flow meter 10, the central axis of hole 141, central orifice 151, and hole 161 are generally aligned with central axis 15. In this arrangement, fluid flows from upstream region 22 of flow meter 10 through hole 141 of first ring 140, through orifice 151 of orifice plate 150, and through hole 161 of second ring 160 to downstream region 24 of flow meter 10. Thus, upstream region 22, hole 141, orifice 151, hole 161, and downstream region 24 are each in fluid communication,

Orifice flow meter 10 including orifice plate assembly 100 is placed in-line with a conduit or pipeline (not shown) in order to measure flow rates, volumetric and/or mass flow rates, through the conduit. During fluid flow, small access pressure ports or pressure taps (not shown) are provided on each side of orifice plate 150 to permit the measurement of pressure differentials across orifice plate 150. The measured pressure differentials may be used to calculate fluid flow rate through flow meter 10.

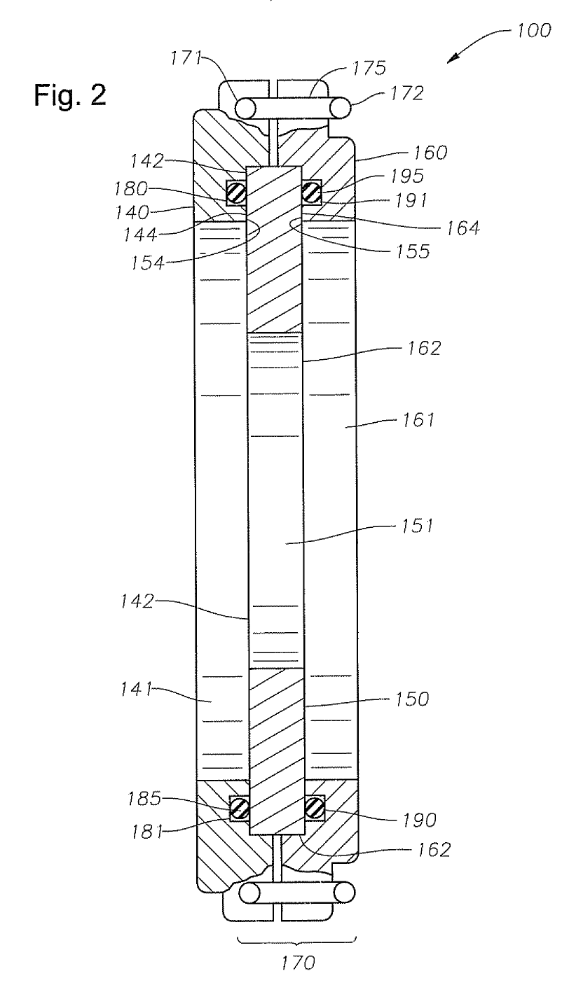

Referring to FIG. 2, orifice plate assembly 100 comprises first ring 140, orifice plate 150, second ring 160, one or more fasteners 170, and one or more seal assemblies 180, 190. Orifice plate 150 is disposed between first ring 140 and second ring 160. Seal assembly 180 creates a fluid tight seal between first ring 140 and orifice plate 150. Further, seal assembly 190 creates a fluid tight seal between second ring 160 and orifice plate 160. One or more fasteners 170 are provided to securely hold the entire orifice plate assembly together. In particular, fasteners 170 clamp the outer radial edges of first ring 140 and second ring 160 together

Orifice plate 150 is a relatively flat thin plate having an orifice 151 in the center. Orifice 151 may be cast or molded as part of orifice plate 150 or machined from orifice plate 150. Orifice 151 has a diameter less than the diameter of passage 21 of flow meter 10. In this manner, fluid flow from upstream region 22 to downstream region 24 is restricted by orifice plate 150. As a result, the fluid pressure upstream orifice plate 150 is greater than the fluid pressure downstream of orifice plate 150. As previously described, this pressure differential may be measured and used to calculate fluid flow rate through orifice flow meter 10 shown in FIG. 1

First ring 140 and second ring 160 each include a through hole 141, 161, respectively, generally of the same diameter as passage 21 of flow meter 10. In this manner, neither first ring 140 nor second ring 160 restricts or otherwise impacts fluid flow through flow meter 10. In different embodiments (not illustrated), hole 141 and/or hole 161 may have a diameter different than passage 21. Further, first ring 140 and second ring 160 each include a recess 142, 162, respectively, that accommodates orifice plate 150 when orifice plate 150 is disposed between first ring 140 and second ring 160.

Seal assembly 180 is positioned between first ring 140 and orifice plate 150. In particular, seal assembly 180 provides a fluid tight seal between surface 144 of first ring 140 and surface 154 of orifice plate 150. In the embodiment illustrated in FIG. 2, seal assembly 180 comprises an O-ring 185 seated within a peripheral annular groove 181 around hole 141 in first ring 140 that sealingly engages surface 154 of orifice plate 150. Annular groove 181 may be cast or mold as part of first ring 140 or machined into first ring 140 at a predetermined location. O-ring 185 may be maintained within groove 181 by any suitable means including without limitation a pressure fit, adhesive, or combinations thereof. In this configuration, seal assembly 180 prevents fluid leakage from orifice flow meter 10, which may otherwise detrimentally impact the accuracy of flow meter 10. In particular, seal assembly 180 is intended to prevent fluid loss between first ring 140 and orifice plate 150.

In select embodiments, O-ring 185 is resiliently deformable and sized slightly larger than groove 181 such that O-Ting 185 is pressure fit within groove 181 and protrudes from surface 144 when seated in groove 181. In such embodiments, when first ring 140, orifice plate 150, and second ring 160 are held tightly together by fastener 170, O-ring 185 is compressed by compressional forces exerted on O-ring 185 by first plate 140 and orifice plate 150. Compression of O-ring 185 between first ring 140 and orifice plate 150 increases the effective sealing surface area and the reliability of the seal.

Seal assembly 190 is positioned between second ring 160 and orifice plate 150. In particular, seal assembly 190 provides a fluid tight seal between surface 164 of second ring 160 and surface 155 of orifice plate 15. In the embodiment illustrated in FIG. 2, seal assembly 190 comprises an O-ring 195 seated within a peripheral annular groove 191 around hole 161 in second ring 160 that sealingly engages surface 155 of orifice plate 150. Annular groove 191 may be cast of mold as part of second ring 160 or machined into second ring 160 at a predetermined location. O-ring 195 may be maintained within groove 191 by any suitable means including without limitation a pressure fit, adhesive, or combinations thereof. In this configuration, seal assembly 190 prevents fluid leakage from orifice flow meter 10, which may otherwise detrimentally impact the accuracy of flow meter 10. In particular, seal assembly 190 is intended to prevent fluid loss between first plate 160 and orifice plate 150.

In select embodiments, O-ring 195 is resiliently deformable and sized slightly larger than groove 191 such that O-ring 195 is pressure fit within groove 191 and protrudes from surface 164 when seated in groove 191. In such embodiments, when first ring 140, orifice plate 150, and second ring 160 are held tightly together by fastener 170, O-ring 195 is compressed by compressional forces exerted on O-ring 195 by second ring 160 and orifice plate 150. Compression of O-ring 195 between second ring 160 and orifice plate 150 increases the effective sealing surface area and the reliability of the seal

Each O-ring 185, 195 may comprise any suitable material capable of creating a fluid tight seal between two surfaces (e.g., sealing between first ring 140 and orifice plate 160) including without limitation metals (e.g., tin, lead, etc.), non-metals (plastic, polymer, rubber, composite, etc.) or combinations thereof. O-ring 185 may be the same material or different material than O-ring 195. As previously discussed, each O-ring 185, 195 preferably comprise a resilient material that deforms elastically to create a seal when compressed. For example, in some embodiments, O-rings 185, 195 comprises an elastomeric rubber. In addition, each O-ring 185, 195 may comprise a corrosive resistant material and/or have a corrosive resistant coating to resist detrimental corrosion by the fluid flowing through orifice flow meter 10.

Although each seal assembly 180, 190 is described above as an O-ring type seal, in general, each seal assembly of orifice plate assembly 100 may comprise any suitable type of seal capable of creating a fluid tight seal between two surfaces. Examples of suitable seals include without limitation O-ring seals, lip seals, wiper seals, dynamic seals, static seals, or combinations thereof. Further, each seal assembly within orifice plate assembly 100 may be the same or different. Generally, O-ring type seal assemblies are preferred for each seal assembly 180, 190 for a variety of reasons including without limitation, O-rings are typically available in variety materials (e.g., corrosive resistant materials) and sizes, O-tings are easily replaceable, O-ring seal assemblies are easily assembled, O-ring seal assemblies eliminates reliance on intricate seals that are cast, molded or machined as integral part of first plate 140 and/or second plate 160, etc,

In some embodiments (e.g., FIG. 2), seal assembly 180 is substantially the same as seal assembly 190. However, in different embodiments (not illustrated), seal assembly 180 is different from seal assembly 190

Since orifice plate 150 partially restricts fluid flow through flow meter 10, the fluid pressure upstream of orifice plate 150 is greater than the fluid pressure downstream of orifice plate 150. As a result, the upstream surface of orifice plate 150 is more vulnerable to fluid leakage and loss than the downstream surface of orifice plate 150. In some embodiments (not illustrated), a seal may be provided only at the upstream surface of the orifice plate (i.e., the surface most susceptible to fluid leakage). For example, in an embodiment, seal assembly 180 is provided to seal between first ring 140 and upstream surface 154 of orifice plate 150, however, seal assembly 190 may be excluded. In such an embodiment, sufficient sealing at the upstream surface of orifice plate 150 is achieved when orifice plate assembly 100 is oriented with first ring 140 and seal assembly 180 on the upstream side of orifice plate 150. However, if such an embodiment is accidentally or inadvertently oriented in the opposite manner, with first ring 140 and seal assembly 180 on the downstream side of orifice plate 150, fluid leakage and loss may occur at the particularly vulnerable upstream side of orifice plate 150 since no seal is provided at the upstream side of orifice plate 150.

In the embodiment illustrated in FIG. 2, a seal is provided at both the upstream side of orifice plate 150 regardless of whether orifice plate assembly 100 is oriented with first ring 140 upstream or downstream of orifice plate 150. For instance, if orifice plate assembly 100 is oriented with first ring 140 upstream of orifice plate 150, seal assembly 180 provides a reliable seal at the upstream surface of orifice plate 150; and if orifice plate assembly 100 is oriented with second ling 160 upstream of orifice plate 150, seal assembly 190 provides a reliable seal at the upstream surface of orifice plate 150. By providing a reliable seal (e.g., seal assembly 180, seal assembly 190) at the upstream surface of orifice plate 150, regardless of the orientation of orifice plate assembly 100 within orifice flow meter 10, orifice plate assembly 100 is bi-directional. In addition to being bi-directional, embodiments of orifice plate assembly 100 having a seal assembly (e.g., seal assembly 180 and seal assembly 190) on both sides of orifice plate 150 advantageously reduce the likelihood of fluid leakage and loss at the downstream surface of orifice plate 150. Although the downstream side of orifice plate 150 is at a lower pressure than the upstream side of orifice plate 150, and is hence less vulnerable to fluid leakage, any potential fluid leakage at the downstream surface of orifice plate 150 is reduced and/or prevented by seal assembly 180 or seal assembly 190, depending on the orientation of orifice plate assembly within orifice flow meter 10.

Thus, by providing a seal assembly 180, 190 to sealingly engage each side of orifice plate 150, orifice plate assembly 100 may be disposed in orifice flow meter 10 with either first ling 140 oriented upstream of orifice plate 150 or second ring 160 upstream of orifice plate 150 without fluid leakage or loss from passage 21 through orifice plate assembly 100.

Still referring to FIG. 2, fasteners 170 are provided to firmly hold the outer radial edges of first ring 140 and second ring 160 together with orifice plate 150 disposed in recesses 142, 162 therebetween. In the embodiment illustrated in FIG. 2, two fasteners 170 are visible. Further, the two visible fasteners 170 are shown as symmetrically arranged substantially 180 degrees apart. However, in general, one or more fasteners 170 may be provided to hold orifice plate assembly 100 together. Further, in some embodiments one or more fasteners 170 are not arranged symmetrically about the outer radial portions of orifice plate assembly 100.

In embodiments in which each O-ring 185, 195 is resiliently deformable, the clamping of first ring 140 to second ring 160 with orifice plate 150 therebetween compresses each O-ring 185, 195. As previously discussed, compression of each O-ring 185, 195 enhances the effective sealing surface area between first ring 140 and orifice plate 150 and between second ring 160 and orifice plate 150. Further, each resilient O-ring 185, 195 responds to such compression by exerting spring-like forces tending to push apart first ring 140 and orifice plate 150 and push apart second ring 160 and orifice plate 150. Such forces are translated by first ring 140 to fastener 170 and by second ring 160 to fastener 170.

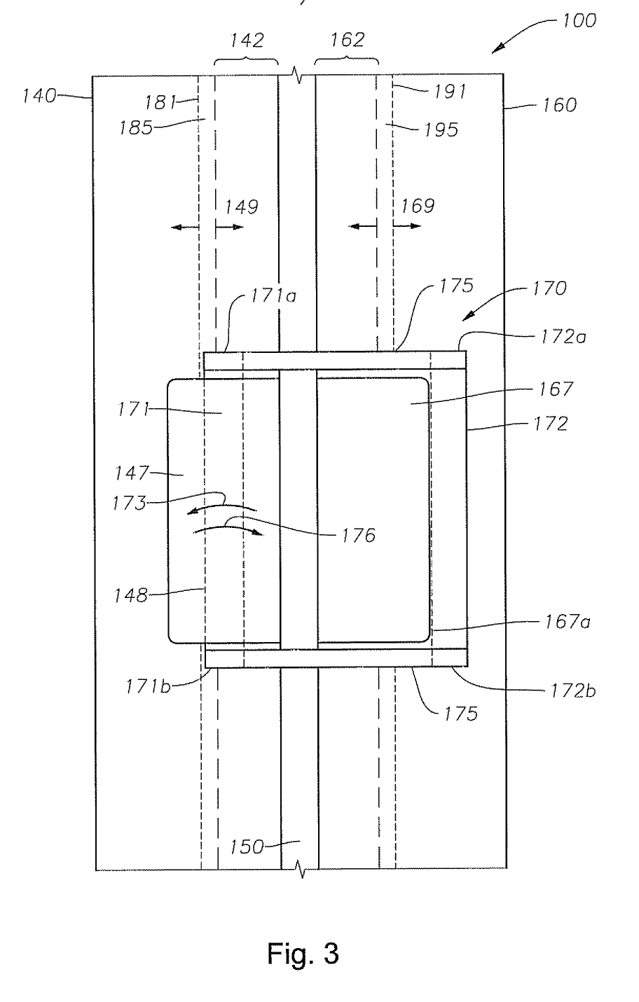

Referring to FIGS. 3-5, fastener 170 comprises a first pin 171 coupled to a second pin 172 by two connecting members 175. One connecting member 175 rigidly connects first end 171a of first pin 171 to first end 172a of second pin 172. Further, another connecting member 175 rigidly connects second end 171b of first pin 171 to second end 172b of second pin 172. Neither first pin 171, second pin 172, nor connecting arms 175 move rotationally or translationally relative to each other. In general, components of fastener 170 (e.g., first pin 171, second pin 172, connecting member 175) may be fixed together by any suitable means including without limitation welding, adhesive, bolts, or combinations thereof. Preferably, the components of fastener 170 are rigidly fixed together such that fastener 170 can withstand forces imposed on first plate 140 and second plate 160 when each resilient O-ring 185, 195 is compressed,

As previously described, fastener 170 is provided to hold orifice plate assembly 100 together when orifice plate 150 is disposed between first ring 140 and second ring 160. Further, fastener 170 is provided to hold first ring 140 and orifice plate 150 sufficiently close such that seal assembly 180 forms a fluid tight seal between first ring 140 and orifice plate 150. Still further, fastener 170 is provided to hold second ring 160 and orifice plate 150 sufficiently close such that seal assembly 190 forms a fluid tight seal between second ring 160 and orifice plate 150.

In the embodiments illustrated in FIGS. 3-5, first pin 171 is disposed in a bore 148 passing through an extension 147 of first ring 140. Extension 147 is a portion of first ring 140 that extends radially from the outer perimeter of first ring 140. First pin 171 does not move translationally relative to first ring 140, however, first pin 171 may move rotationally within bore 148 relative to first ring 140 generally in the direction of arrows 173 and arrows 176. As first pin 171 rotates within hole 148, fastener 170 generally pivots about first pin 171.

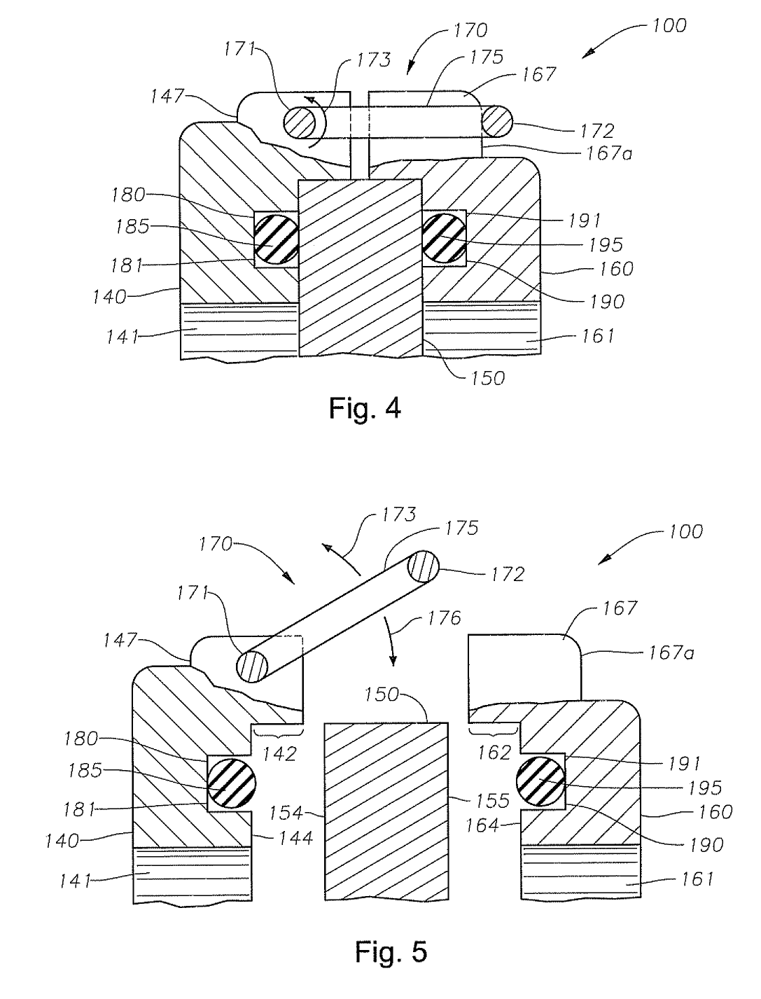

Second pin 172 engages surface 167a of extension 167 of second ring 160 when fastener 170 is in the “locked position” illustrated in FIGS. 3 and 4. Extension 167 is a portion of second ring 160 that extends radially from the outer perimeter of second ring 160. Extension 167 of second ring 160 is generally aligned with extension 147 of first ring 140 such that connecting members 175 can be positioned on either side of extension 167 when fastener 170 is in the “locked position.” When fastener 170 is in the “locked position,” second ring 160 is not free to move translationally relative to first ring 140. Further; when fastener 170 is in the “locked position,” orifice plate assembly 100 is held rigidly together.

In select embodiments, the dimensions of first ring 140 (e.g., recess 142, extension 147, etc.), orifice plate 150, second ring 160 (e.g., recess 162, extension 167, etc.), and fastener 170 are selected such that when fastener 170 is in the “locked position,” each resilient O-ring 185, 195 is sufficiently compressed against orifice plate 150 to create a fluid tight seal. Without being limited by theory, the more each O-ring 185, 195 is compressed and deformed, the greater the sealing surface area and the better the resulting seal. However, by compressing each resilient O-ring 185, 195, forces generally in the direction of arrows 149 act on first plate 140 and forces generally in the direction of arrows 169 act on second plate 160. These forces are translated through first ring 140 and second ring 160 to fastener 170, as best illustrated in FIG. 3. However, by rigidly securing extension 147 of first ring 140 to extension 167 of second ring 160, fastener 170 prevents these forces from pushing apart first ring 140 and second ring 160. In particular, fastener 170 rigidly holds orifice plate assembly 100 together in the “locked position” by restricting second ring 160 from moving apart from first ring 140.

FIG. 5 illustrates fastener 170 in the “unlocked position,” Fastener 170 is placed in the “unlocked position” by pivoting fastener 170 about the longitudinal axis of first pin 171 generally in the direction of arrow 173 until second pin 172 no longer engages surface 167a. Once each fastening member 170 provided on orifice plate assembly 100 is in the “unlocked position,” second ring 160 is free to be separated from first ring 140 and orifice plate 150. Further, once first ring 140 and second ring 160 are separated, orifice plate 150 may be completely removed from recesses 142, 162. Each fastener 170, and hence orifice plate assembly 100, may be opened for a variety of reasons including without limitation to repair a broken or damaged component of orifice plate assembly 100 (e.g., fastener 170), to replace a component of orifice plate assembly 100 (e.g., replace orifice plate 150 with another orifice plate, replace a pressure tap on orifice plate 150), inspect a component of orifice plate assembly 100 (ergo, to inspect seal assembly 180), or combinations thereof.

Still referring to FIG. 5, orifice plate assembly 100 may be reassembled and prepared for insertion into orifice flow meter 10 by positioning orifice plate 150 between first ring 140 and second ring 160 within recess 142 and recess 162, respectively; compressing first ring 140 and second ring 160 sufficiently together; pivot fastener 170 in the direction of arrow 176 until fastener 170 is positioned around extension 167 of second ring 160; and then release first ring 140 and second ring 160 allowing surface 167a to engage second pin 172 as shown in FIGS. 3 and 4.

The components of fastener 170 (e.g., connecting member 175, first pin 171, second pin 172) may comprise any suitable material(s) including without limitation metals and metal alloys (e.g., aluminum, steel, etc.), non-metals (composites, plastic, ceramics, etc.) or combinations thereof. Preferably, the components of fastener 170 comprise materials having sufficient strength and rigidity to withstand forces generated by compressing one or more resilient seals (e.g., O-ring 185, O-ring 195). Further, in some embodiments, the components of fastener 170 may comprise corrosive resistant materials (e.g., stainless steel, zinc, etch) and/or have a corrosive resistance coating (e.g., plastic coating, etch).

In the manner described, fastener 170 is provided to rigidly hold orifice plate assembly 100 together. In addition, to ensure sufficient compression of each O-ring 185, 195 to generate fluid tight seals, the dimensions of each component of orifice plate assembly 100 (e.g., first ring 140, second ring 160, orifice plate 150, fastener 170, etc.) are critical. Without being limited by theory, from a manufacturing perspective, consistent production of parts with requiring particular dimensions typically calls for strict adherence to relatively tight manufacturing tolerances for each particular component of orifice plate assembly 100. For instance, if connecting arms 175 are slightly too long, an insufficient seal may be formed by seal assembly 180 or seal assembly 190 (i.e., there may no be enough compression of each O-ring 185, 195). In general, the more specific and tighter the dimensional tolerances, the greater the manufacturing costs. Further, the greater the number of components in orifice plate assembly 100, the greater the assembly cost to manufacture orifice plate assembly 100. Thus, a reduction in the number of interconnected components necessary to sufficiently seal orifice plate assembly 100 may somewhat relax the required dimensional tolerances, thereby reducing component manufacturing costs, as well as reduce assembly costs for orifice plate assembly 100. Still further, a reduction in the number of interconnected components require for orifice plate assembly 100 may reduce the inventory of parts required on-hand to maintain and/or repair orifice plate assembly 100. For example, if the clip fastener 170 illustrated in FIG. 3 is replaced with a fastening means integral with first ring 140, then an operator of orifice flow meter 10 does not need to separately stock inventory of clip fastener 170,

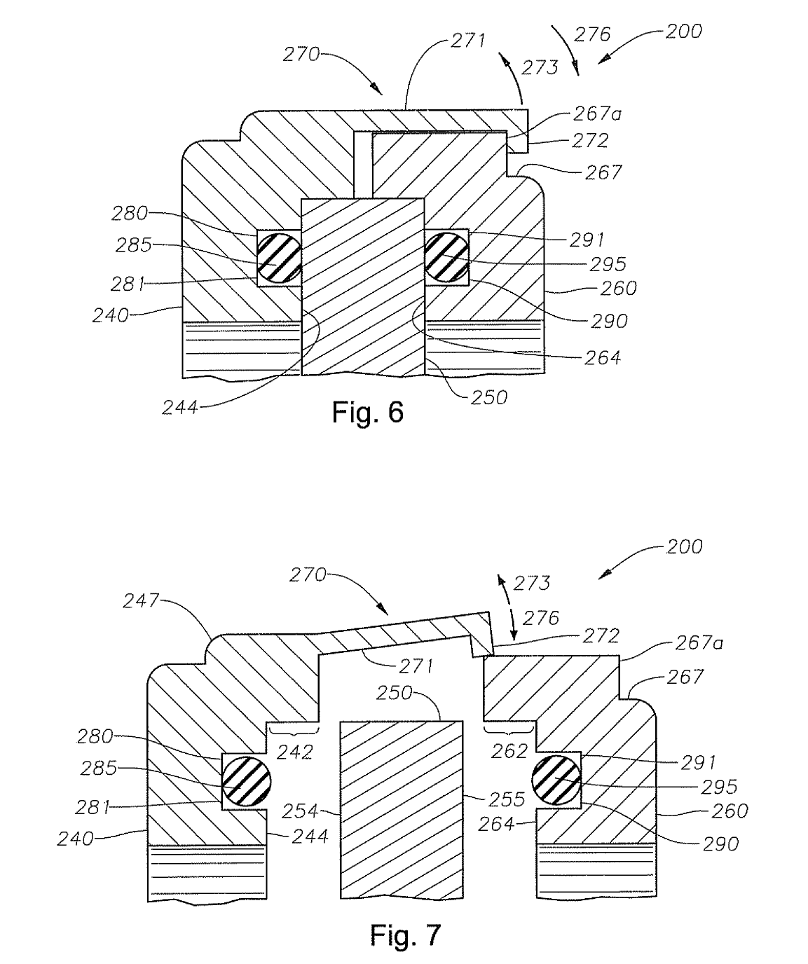

FIGS. 6 and 7 illustrate an alternative embodiment of orifice plate assembly 200. The embodiment of orifice plate assembly 200 illustrated in FIGS. 6 and 7 is generally equivalent to the embodiment of orifice plate assembly 100 illustrated in FIGS. 2-5 with the exception of the fastening means used to hold the assembly together and compress the sealing mechanism(s).

Referring to FIGS. 6 and 7, fastener 270 comprises an arm 271 extending from the outer radial surface of first ring 240 having a attachment member 272 at its free end distal first ring 240. Arm 271 extends substantially perpendicular to sealing surface 244 of first ring 240. In the embodiment illustrated in FIGS. 6 and 7, arm 271 is integral with first ring 240, and attachment member 272 is integral with arm 271. Arm 271 and attachment member 272 may be molded or cast as part of first ring 240, or machined as part of first ring 240. In different embodiments (not illustrated), arm 271 is a distinct, separate component that is physically fixed to the outer perimeter of first ring 240. In the embodiment illustrated in FIGS. 6 and 7, attachment member 272 generally has the shape of a hook. However; in different embodiments (not illustrated), attachment member 272 may have any suitable geometry permitting releasable engagement with second ring 260.

Arm 271 is effectively cantilevered from the outer surface of first ring 240. As a result, arm 271 behaves like a resilient spring when flexed relative to first ring 240. Thus, when arm 271 is flexed in the direction of arrow 273, arm 271 generates a restoring force generally in the direction of arrow 276. This spring-like characteristic of arm 271 aids in maintaining fastener 270 in the “locked position” shown in FIG. 6.

Referring specifically to FIG. 6, when orifice assembly 200 is in the “locked position,” arm 271 extends from first ring 240 and across the radial surface of second ring 260 until attachment member 272 engages a mating notch 267 provided in the outer radial surface of second ring 260. In particular, engagement of attachment member 272 with surface 267a of notch 267 prevents second ring 260 and orifice plate 250 from moving translationally relative to first ring 240. In other words, when orifice plate assembly 200 is in the “locked position,” fastener 270 prevents the separation of first ring 240, orifice plate 250, and second ring 260. In addition, once orifice assembly 200 is in the “locked position,” the restoring spring feature of arm 271 resists flexion in the direction of arrow 273, which may otherwise result in disengagement of attachment member 272 and notch 267 of second ring 260. Thus, in the “locked position” illustrated in FIG. 6, fastener 270 rigidly holds together first ring 240 and a second ring 260 when an orifice plate 250 is placed therebetween. Further; when fastener 270 is in the “locked position,” second ring 260 is not free to move translationally relative to first ring 240.

In select embodiments, the dimensions of each component of orifice assembly 200 (e.g., first ring 240, second ring 260, and fastener 270, etc.) are selected such each resilient O-ring 285, 295 is compressed when orifice plate assembly 200 is in the “locked position.” Compression and resulting deformation of each O-ring 285 295 increases the sealing contact surface area and enhances the sealing engagement of each seal assembly 280, 290 with orifice plate 250. However, compression of each O-ring 285,295 results in forces tending to push apart first ring 240 and second ring 260. In the “locked position,” fastener 270 rigidly holds orifice plate assembly 200 together by restricting second ring 260 from moving apart from first ring 140 and orifice plate 150

FIG. 7 illustrates orifice plate assembly 200 in the “unlocked positions” Orifice plate assembly 200 may be opened by flexing arm 271 and attachment member 272 generally in the direction of arrow 273 until attachment member 272 disengages notch 267 of second ring 260. Since arm 271 exerts a restoring spring force opposing flexion, some force may be necessary to sufficiently flex arm 271 to permit disengagement of attachment member 272 and notch 267. When fastener 270 is in the “unlocked position,” second ring 260 is flee to move relative to first ring 240. Once each fastening member 270 provided on orifice plate assembly 200 has been opened, first ring 240, second ring 260, and orifice plate 250 are free to be separated apart

Orifice plate assembly 200 may be reassembled and prepared for insertion into orifice flow meter 10 by positioning orifice plate 250 between first ring 240 and second ring 260 within recess 242 or recess 262; simultaneously compressing first ring 240 and second ring 260 together and flexing arm 271 generally in the direction of arrow 273 until each O-ring 285, 295 sufficiently engages orifice plate 250 and attachment member 272 can engage notch 267 as shown in FIG. 6G

Fastener 270 may comprise any suitable material(s) including without limitation metals and metal alloys (e.g., aluminum, steel, etc.), non-metals (composites, plastic, ceramics, etc.) or combinations thereof. In certain embodiments, fastener 270 comprises a relatively strong, flexible, resilient material having sufficient strength to maintain sufficient sealing, sufficiently flexibility to permit flexion to open orifice plate assembly 200, and sufficient resiliency to provide a restoring force resisting flexion and tending to maintain a “locked position.” Further, in some embodiments, the components of fastener 170 may comprise corrosive resistant materials (e.g., stainless steel, zinc, etc.) and/or have a corrosive resistance coating (ergo, plastic coating, etch). In embodiments in which fastener 270 is integral with first ring 240, fastener 270 and first ring 240 may comprise the same material

In the manner described, fastening member 270 illustrated in FIGS. 6 and 7 provides a means to securely open and close orifice plate assembly 200 while enhancing the sealing ability of each seal assembly 280, 290 positioned on either side of orifice plate 250.

As compared to orifice plate assembly 100 illustrated in FIGS. 4 and 5, orifice plate assembly 200 illustrated in FIGS. 6 and 7 includes fewer component parts. For instance, fastener 170 shown in FIGS. 4 and 5 is a distinct and separate part that may be separately manufactured, separately assembled, and then coupled to first plate 140 to assemble orifice plate assembly 100. However, the embodiment of fastener 270 illustrated in FIGS. 6 and 7 is manufactured integral with first ring 240, does not require separate assembly, and does not require additional steps to couple it to orifice plate assembly 200. As previously discussed, without being limited by theory, by reducing the number of interconnected separate components required for an orifice plate assembly (e.g., orifice plate assembly 100), manufacturing tolerances for each component may be somewhat relaxed. Such a relaxation in manufacturing tolerances may desirably reduce manufacturing costs of the orifice plate assembly. In addition, by employing fastener 270 integral with first ring 240, the need for on-hand inventory, and associated expense, of separate and distinct fastener 170 may be eliminated. Still further, by employing fastener 270 integral with first ring 240 the need to separately couple fastener 270 to first ring 240 to assembly orifice plate assembly 200 is eliminated, thereby further reducing assembly expenses.

First ring 140, 240, second ring 160, 260, and orifice plate 150, 250 may each comprise any suitable material including without limitation metals and metal alloys (e.g., aluminum, steel, etc.), non-metals (e.g., plastics, ceramics, fiber composites, etc.) or combinations thereof. Preferably, first ring 140, 240, second ring 160, 260, and orifice plate 150, 250 are each sufficiently rigid and strong to withstand the pressure differentials between upstream region 22 and downstream region 24 of flow meter 10. Further, in some embodiments, first ring 140, 240, second ring 160, 260, and orifice plate 150, 250 may each comprise a corrosive resistant material (e.g., stainless steel, plastic, etc.) and/or have a corrosive resistance coating. The choice of materials for first ring 140, 240, second ring 160, 260, and orifice plate 150, 250 will ultimately depend on a variety of factors including without limitation the application of flow meter 10, the pressure differentials in flow meter 10, the type of fluid(s) flowing through flow meter 10, or combinations thereof.

While preferred embodiments of this invention have been shown and described, modifications thereof can be made by one skilled in the art without departing from the scope or teaching of this invention. The embodiments described herein are exemplary only and are not limiting. Many variations and modifications of the system and apparatus are possible and are within the scope of the invention. For example, the relative dimensions of various parts, the materials from which the various parts are made, and other parameters can be varied, so long as the interstitial insulation retains the advantages discussed herein. Accordingly, the scope of protection is not limited to the embodiments described herein, but is only limited by the claims that follow, the scope of which shall include all equivalents of the subject matter of the claims.

What is claimed is:

1. An orifice flow meter comprising:
a tubular body having a through passage;
an orifice plate assembly removably disposed within the body across the through passage;
wherein the orifice plate assembly includes an orifice plate disposed between a first ring and a second ring; and
wherein a first seal assembly is disposed between the first ring and the orifice plate, and a second seal assembly is disposed between the second ring and the orifice plate.

2. The flow meter of claim 1 wherein the first seal assembly comprises an O-ring seated within an annular groove in the first ring, and the second seal assembly comprises an O-ring seated within an annular groove in the second ring.

3. The flow meter of claim 2 wherein the orifice plate assembly further comprises at least one fastener coupled to the first ring and operable to releasably engage the second ring.

4. The flow meter of claim 3 wherein the at least one fastener has a locked position engaging the second ring, wherein the first ring, the second ring, and the orifice plate are held together, and an unlocked position wherein the second ring is free to move relative to the first ring.

5. The flow meter of claim 4 wherein the O-ring of the first seal assembly and the O-ring of the second seal assembly are compressed when the at least one fastener is in the locked position.

6. The flow meter of claim 1 further comprising at least one fastener integral with the first ring.

7. The flow meter of claim 6 wherein the at least one fastener comprises an arm extending from a radial surface of the first ring, and wherein the arm is operable to releasably engage the second ring.

8. The flow meter of claim 7 wherein the at least one fastener has a locked position releasably engaging the second ring and restricting the second ring from moving translationally relative to the first ring, and an unlocked position wherein the second ring is free to move relative to the first ring.

9. An orifice plate assembly for an orifice flow meter comprising:
a first ring;
a second ring;
an orifice plate disposed between the first ring and the second ring; and
at least one fastener integral with the first ring, wherein the fastener is operable to releasably engage the second ring.

10. The orifice plate assembly of claim 9 further comprising a first seal assembly disposed between the first ring and the orifice plate and a second seal assembly disposed between the second ring and the orifice plate.

11. The orifice plate assembly of claim 10 wherein the first seal assembly comprises an O-ring seated in an annular groove in the first ring and the second seal assembly comprises an O-ring seated in an annular groove in the second ring.

12. The orifice plate assembly of claim 11 wherein each O-ring comprises resilient rubber.

13. The orifice plate assembly of claim 9 wherein the at least one fastener extends from an outer radial surface of the first ring.

14. The orifice plate assembly of claim 13 wherein the at least one fastener has a locked position releasably engaging the second ring and restricting the second ring from moving translationally relative to the first ring, and an unlocked position wherein the second ring is free to move relative to the first ring.

15. An orifice plate assembly for an orifice flow meter comprising:
a first ring;
a second ring;
an orifice plate disposed between the first ring and the second ring;
a first seal assembly disposed between the first ring and the orifice plate; and
a second seal assembly disposed between the second ring and the orifice plate.

16. The orifice plate assembly of claim 15 wherein the first seal assembly comprises an O-ring seated in an annular groove in the first ring and the second seal assembly comprises an O-ring seated in an annular groove in the second ring.

17. The orifice plate assembly of claim 16 wherein each O-ring comprises resilient rubber.

18. The orifice plate of claim 15 further comprising at least one fastener integral with the first ring, wherein the at least one fastener extends from an outer radial surface of the first ring and includes an attachment member at an end distal the first ring, wherein the attachment member is operable to releasably engage the second ring.

19. The orifice plate assembly of claim 18 wherein the at least one fastener has a locked position wherein the attachment member releasably engages the second ring and restricts the second ring from moving translationally relative to the first ring, and an unlocked position wherein the second ring is free to move relative to the first ring.
